(19) United States
(12) Patent Application Publication
(10) Pub. No.: US 2026/0322619 A1
(43) Pub. Date: Oct. 15, 2026

(54) AUTHENTICATING PHYSICAL CONNECTORS FOR IMPROVED COMPUTER SYSTEM SECURITY

(71) Applicant: INTERNATIONAL BUSINESS MACHINES CORPORATION, Armonk, NY (US)

(72) Inventors: Michael Terrence COHOON, Fishkill, NY (US); Torin REILLY, Beacon, NY (US); Christopher Vincent DEROBERTIS, Hopewell Junction, NY (US)

(21) Appl. No.: 19/175,728

(22) Filed: Apr. 10, 2025

(51) Int. Cl. H04L 9/32

(52) U.S. Cl. CPC H04L 9/3247

(57) ABSTRACT

Authenticating physical connectors for improved computer system security is disclosed. In an embodiment, the mechanical insertion of a connector into a connection interface of a device is detected. A signature embedded in the connector is validated. Data communication through the connection interface is enabled in response to determining that the signature is valid. The signature is then invalidated.

### BACKGROUND

The present disclosure relates to methods, apparatus, and products for authenticating physical connectors for improved computer system security. Enterprise computing environments, data centers, and server labs contain the boxes, adapters, processors, switches, wiring, and other physical hardware needed to run a computing system. Access to the physical devices and componentry is often very restricted, requiring credentials and authorization to access the lab floor. While there are mitigation techniques to identify and limit an internal bad actor when dealing with software, an onsite attack that replaces physical componentry is also significant security concern. An onsite bad actor may have the opportunity to swap cables, add in-the-middle devices, and perform other physical changes that may go unnoticed.

### SUMMARY

According to embodiments of the present disclosure, various methods, apparatus and products for authenticating physical connectors for improved computer system security are described herein. In some aspects, authenticating physical connectors for improved computer system security includes detecting the mechanical insertion of a connector into a connection interface of a device. A signature embedded in the connector is validated. Data communication through the connection interface is enabled in response to determining that the signature is valid. The signature is then invalidated. Thus, upon successful validation of the signature, the device enables data communication through the connection interface. Invalidating the signature post-validation ensures secure and controlled access. This approach provides an additional layer of security by ensuring that only authorized connectors can establish data communication with the device, and cannot be removed and reinserted to alter the connectivity of the device, thereby mitigating potential security threats associated with unauthorized access.

### BRIEF DESCRIPTION OF THE DRAWINGS

FIG. 1 sets forth a block diagram of an example system for authenticating physical connectors for improved computer system security in accordance with at least one embodiment of the present disclosure.

FIG. 2 sets forth a flowchart of an example method of authenticating physical connectors for improved computer system security in accordance with at least one embodiment of the present disclosure.

FIG. 3 sets forth a flowchart of another example method of authenticating physical connectors for improved computer system security in accordance with at least one embodiment of the present disclosure.

FIG. 4 sets forth a flowchart of another example method of authenticating physical connectors for improved computer system security in accordance with at least one embodiment of the present disclosure.

FIG. 5 sets forth a flowchart of another example method of authenticating physical connectors for improved computer system security in accordance with at least one embodiment of the present disclosure.

FIG. 6 sets forth an example computing environment in accordance with at least one embodiment of the present disclosure.

### DETAILED DESCRIPTION

Enterprise computing environments, data centers, and server labs contain the boxes, adapters, processors, switches, wiring, and other physical hardware needed to run a computing system. Access to the physical devices and componentry is often very restricted, requiring credentials and authorization to access the lab floor. While there are mitigation techniques to identify and limit an internal bad actor when dealing with software, an onsite attack that replaces physical componentry is also a significant security concern. An onsite bad actor may have the opportunity to swap cables, add in-the-middle devices, and perform other physical changes that may go unnoticed.

Embodiments in accordance with the present disclosure prevent unauthorized or unapproved modifications to physically connected, or “plugged,” components, such as networking cables, by implementing security mechanisms that allow only authorized cables to be used and ensure that these cables cannot be reused once disconnected. This mechanism prevents cables from being moved, tampered with, and subsequently reconnected to a system. A core functionality lies in the ability to verify, for a given port in a system, the authenticity of a connected cable. To achieve this, the system reads a unique signature embedded in the connected component (e.g., embedded in the connector). This signature may be verified using a protected signing key or referenced against a stored record in a datastore accessible by the system.

In one example, the connecting component contains a unique signature stored on an NFC chip. Upon connection, the system reads the signature using an NFC reader and verifies its validity. If the device lacks a valid signature, the port remains inactive. Conversely, if the signature is authenticated, the port is activated. Following verification, the signature is rendered unusable to prevent reuse. This can be achieved through a variety of techniques. In one example, after successful verification, the signature is erased from the NFC chip using an NFC writer. In another example, the signature is deleted from the system’s datastore, preventing future validation. In yet another example, the signature remains intact until the device is disconnected. A mechanical intervention can be employed to ensure destruction of the signature upon removal. For example, in the case of an Ethernet cable, compressing the locking mechanism during disconnection could cause the NFC chip to physically break, rendering it incapable of transmitting its signature. Additionally, other mechanical actions may be employed to invalidate the signature upon approval for use. All of these techniques ensure that the cable cannot be immediately reused or reconnected to the system.

In other examples, the signature is not read or written wirelessly; instead, any form of wired identification chip may be utilized. To mitigate the risk of potential interception of wireless signals, an additional pin can be incorporated within the head of an RJ45 connector, requiring a physical connection between the male and female adapters to transmit the signature. One approach to implementing this would be embedding a field-programmable gate array (FPGA) into the head of the RJ45 cable. Once the device is verified, the system could reprogram the FPGA to remove the signature and/or employ technologies such as anti-fuses, which prevent FPGAs from being reprogrammed. Once activated, the anti-fuse would permanently disable both the probing and programming interfaces, ensuring that the signature cannot be restored or altered.

Accordingly, an embodiment in accordance with the present disclosure is directed to a method of authenticating physical connectors for improved computer system security. The method includes detecting a mechanical insertion of a connector into a connection interface of a device. The method also includes validating a signature embedded in the connector. The method also includes enabling data communication through the connection interface in response to determining that the signature is valid. The method also includes invalidating the signature. In some examples, the signature is wirelessly read from the connector. In other examples, the signature is read from the connector over a physical interface. In some examples, the signature is invalidated in response to determining that the signature is valid. In other examples, the signature is invalidated upon removal of the connector from the connection interface.

In some examples, the method also includes disabling data communication through the connection interface in response to detecting a disruption in communication. In some examples, invalidating the signature includes erasing the signature from the connector. In other examples, invalidating the signature includes modifying a signature datastore. For example, the signature datastore may be modified to remove the signature from the signature datastore, or an entry for the signature in the signature datastore may be marked as invalid.

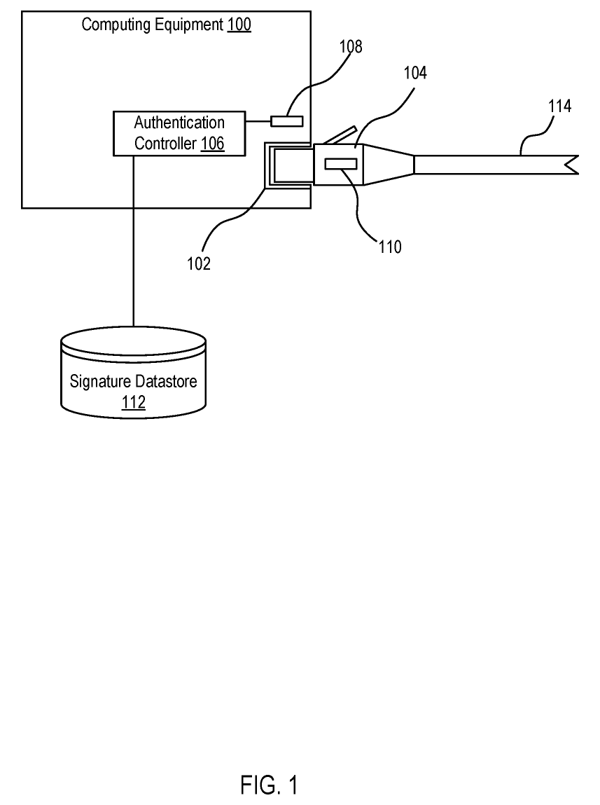

For further explanation, FIG. 1 sets forth a system for authenticating physical connectors for improved computer system security in accordance with at least one embodiment of the present disclosure. FIG. 1 includes a sectional view of computing equipment 100 configured for authenticating physical connectors for improved computer system security in accordance with at least one embodiment of the present disclosure. Computing equipment 100 may be, for example, a computer, network device, or storage device such as a server, router, bridge, storage system, mainframe, and the like. Computing equipment 100 may be part of a system of computing equipment owned or leased by an organization. In a particular example, the system of computing equipment may be located in a datacenter. As such, the organization may be a tenant of the datacenter that serves multiple tenants, thus giving rise to security concerns such as physically tampering with component connections in the system. However, it will be appreciated that such a system may be deployed on-premises, although in such cases the system is still vulnerable to tampering.

Computing equipment 100 includes multiple connection interfaces 102 for physically coupling with a connector for data communications. As used herein, ‘connection interface’ refers to a physical interface such as a port, jack, socket, or slot for receiving a data communications connector. For example, connection interface 102 may be a physical port such as Ethernet (RJ45); Small Form-factor Pluggable (SFP); Enhanced SFP (SFP+); Quad SFP (QSFP); Direct Attach Cable (DAC); Active Optical Cable (AOC); Universal Serial Bus (USB-A, USB-C); Serial Advanced Technology Attachment (SATA); External SATA (eSATA); FICON (fiber connection) channel; and the like. Similarly, connection interface 102 may be a physical slot such as a Peripheral Component Interconnect Express (PCIe) slot that receives a connector on a PCIe card. Other types of connection points, including proprietary connection interfaces, are also contemplated.

To connect computing equipment 100 to other computing equipment, computing equipment 100 receives a connector 104 at connection interface 102. In various examples, connector 104 may be an Ethernet (RJ45) plug, an SFP/SFP+/QSFP connector, a DAC connector, AOC coupler, USB-A or USB-C plug, an SATA/eSATA connector, a FICON connector, and the like. In some examples, connector 104 is part of a cable 114. That is, connector 104 is integrated with cable 114. As an example, connector 104 may be an RJ45 plug of an Ethernet cable. In other examples, connector 104 is an intermediary device that is not integrated with cable 114. For example, cable 114 may be removeable from connector 104. In such an example, connector 104 is inserted into connection interface 102, and cable 114 is inserted into connector 104. Other types of connectors, including proprietary connectors, are also contemplated.

In accordance with embodiments of the present disclosure, connector 104 includes an embedded signature. For example, the signature may be programmed into connector 104 by a technician responsible for maintaining an organization’s computing equipment prior to deploying the connector/cable in a datacenter that includes that computing equipment. In some examples, the signature is a plaintext unique identifier. In other examples, the signature is a protected key. The signature is embedded in connector 104 by storing or configuring the signature in a signature storage element 110. In some examples, signature storage element 110 is a radio frequency identification (RFID) tag or RFID chip. In other examples, signature storage element 110 is a Near Field Communications (NFC) tag or NFC chip, or similar element configured for inductive coupling. In still further examples, signature storage element 110 is a programmable logic device or programmable memory device. For example, signature storage element 110 may be a field programmable gate array (FPGA) or similar logic device. In various examples, signature storage element 110 may be read-only or both readable and modifiable (e.g., by writing or erasure).

Computing equipment 100 includes an authentication controller 106 configured to read the signature embedded in connector 104. In some implementations, authentication controller 106 reads the embedded signature from the signature storage element 110 through wireless communications interface 108. For example, wireless communications interface 108 may be an inductive coupling device such as an NFC protocol device. In another example, wireless communications interface 108 may be a radio wave transceiver device such as a Bluetooth protocol device. It will be appreciated that other types of wireless communication may be employed. In other implementations, authentication controller 106 reads the embedded signature from the signature storage element 110 through a physical interface such as a wire, pin, or lead of the connector 104. For example, in the case of an Ethernet connector, an additional pin can be included inside the head of an RJ45 plug such that a physical connection is used to read/transmit the signature. In some examples, authentication controller 106 is configured to modify or write to the signature storage element 110 as well as read from it.

Authentication controller 106 is configured to authenticate connector 104 by validating the signature embedded in connector 104 prior to enabling communication through connection interface 102 and connector 104. In some implementations, authentication controller 106 validates the signature using a protected key such as a private encryption key. For example, the signature may include signed plaintext data (e.g., a connector identifier) and a digital signature. In these implementations, authentication controller 106 can validate the signature by applying the private encryption key to the plaintext and comparing the encrypted plaintext to the digital signature, or by decrypting the digital signature and comparing the decrypted plaintext to the received plaintext.

In other implementations, authentication controller 106 validates the signature by comparing the signature to entries in a signature datastore 112. For example, signature datastore 112 may include a list of valid signatures that have been programmed into connectors 104 for use with an organization’s computing equipment. After programming a connector 106 with a signature, that signature can be added to signature datastore 112 to facilitate authentication of the connector 104. Upon insertion of the connector 104 into computing equipment 100, authentication controller 106 reads the signature from signature storage element 110 and cross-references the signature with entries in signature datastore 112. If the signature matches an entry in signature datastore 112, connector 104 is authenticated by authentication controller 106. In some examples, signature datastore 112 is remote from computing equipment 100 as shown in FIG. 1. In other examples, the list of valid signatures in signature datastore 112 may be replicated to and stored in local storage in computing equipment 100. It will be appreciated that other techniques for validating the signature, as will occur to those of skill in the art, may be employed to authenticate connector 104.

Upon validating the signature embedded in connector 104, connection interface 102 is activated, thus enabling network traffic over connection interface 102 and connector 104. Connection interface 102 is activated if and only if the signature is validated. If the signature is not validated, connection interface 102 is not activated and network traffic is blocked or rejected. In this way, detecting the presence of connector 104, validating the embedded signature, and enabling network traffic only if the signature is validated prevents network intrusion potentially carried out by plugging an unauthorized cable into computing equipment 100, where a bad actor may attempt to connect computing equipment 100 to a foreign system not operated by the organization.

In some implementations, authentication controller 106 invalidates the embedded signature. This ensures that connector 104 can only be connected to a piece of computing equipment once without reprogramming connector 104 with a new valid signature. In this way, the signature and thus connector 104 are configured for one-time use. Invalidating the signature for one-time use further prevents network intrusion by ensuring that a cable cannot be swapped into a different connection interface 102, or reinserted into the same connection point after removing and tampering with the connector/cable.

In some examples, authentication controller 106 invalidates a signature by erasing or otherwise corrupting the signature embedded in connector 104. For example, where signature storage element 110 in connector 104 is an NFC chip, authentication controller 106 may use an NFC controller to erase or overwrite the signature stored the NFC chip after reading and validating the signature. In this way, authentication controller 106 in computing equipment 100 (or another authentication controller on a different piece of computing equipment in the system) will not authenticate connector 104, and any connection interface 102 into which connector 104 is inserted will remain blocked to network traffic. This ensures that connector 104 is a one-time use connector and cannot be unplugged and reinserted or swapped into different computing equipment without reprogramming connector 104.

In other examples, authentication controller 106 invalidates a signature by erasing the signature from signature datastore 112. In a variation, authentication controller 106 invalidates the signature by marking the entry for the signature in signature datastore 112 as invalid. In this way, authentication controller 106 or a different piece of computing equipment in the system will not authenticate connector 104, and any connection interface 102 into which connector 104 will remain blocked to network traffic. This ensures that connector 104 is a one-time use connector and cannot be unplugged and reinserted or swapped into different computing equipment without reprogramming connector 104.

In still further examples, authentication controller 106 invalidates a signature by adding the signature to a block list. For example, after reading and validating the embedded signature, the signature may be added to a block list stored in, for example, signature datastore 112. In this example, as part of validating the signature that is read from a connector, authentication controller 106 cross-references the signature with the block list. If the signature is on the block list, the signature is not validated and connection interface 102 remains blocked to network traffic. In this way, authentication controller 106 in computing equipment 100 or a different piece of computing equipment in the system will not authenticate connector 104. This ensures that connector 104 is a one-time use connector and cannot be unplugged and reinserted or swapped into different computing equipment without reprogramming connector 104 with a valid signature.

In some implementations, where signature storage element 110 is a programmable logic device and the signature is read through a physical interface, authentication controller 106 can invalidate the signature by erasing the signature from the programmable logic device. For example, where the programmable logic device that is used as signature storage element 110 is an FPGA, the FPGA may be reprogrammed to remove the signature after validation. In some examples, anti-fuses may be employed to prevent the FPGA from being reprogrammed. Once enabled the anti-fuse can prevent both the probe and programming interface in the FPGA from being accessed. An anti-fuse FPGA cannot be tampered with and can only be reverse engineered by physically viewing the state of gates in the FPGA via, for example, an electron microscope. In this way, authentication controller 106 in computing equipment 100 or a different piece of computing equipment in the system will not authenticate connector 104. This ensures that connector 104 is a one-time use connector and cannot be manipulated for accessing computing equipment in the system.

Although the above examples are discussed in the context of invalidating the signature in connector 104 once the signature is validated, in some examples the signature may be invalidated upon removal of connector 104 from connection interface 102. For example, port locks may used to ensure that connector 104 cannot be removed until the port is deactivated. Prior to or contemporaneous with unlocking the port, authentication controller 106 may invalidate the signature on the connector.

In some examples, the signature is invalidated by mechanically destroying signature storage element 110 or a wireless transmission device in connector 104 upon removal from computing equipment 100. For example, signature storage element 110 may be configured in connector 104 such that operating a physical locking/release mechanism (e.g., pressing a release tab) breaks signature storage element 110. In a particular example, an NFC chip may be located in an RJ45 connector such that pressing the tab to release the RJ45 connector from the port breaks the NFC chip, thus preventing connector 104 from transmitting a signature. In this way, authentication controller 106 in computing equipment 100 or a different piece of computing equipment in the system will not authenticate connector 104, thus ensuring one-time use of the connector 104.

In some implementations, after activating connection interface 102 and enabling communication, authentication controller 106 disables connection interface 102 in response to detecting a disruption in network traffic. For example, connection interface 102 may be deactivated in response to detecting a removal of a connector or a disruption in a communications session (e.g., a TCP/IP session). After detecting the disruption, network traffic on the port is blocked/rejected. In a particular example, slicing and splicing of the wiring of the cable, or tapping the cable, will cause a disruption in network traffic that is detected by authentication controller 106. In response, authentication controller 106 disables the port, thus preventing the tapping of the cable in furtherance of network intrusion by a bad actor.

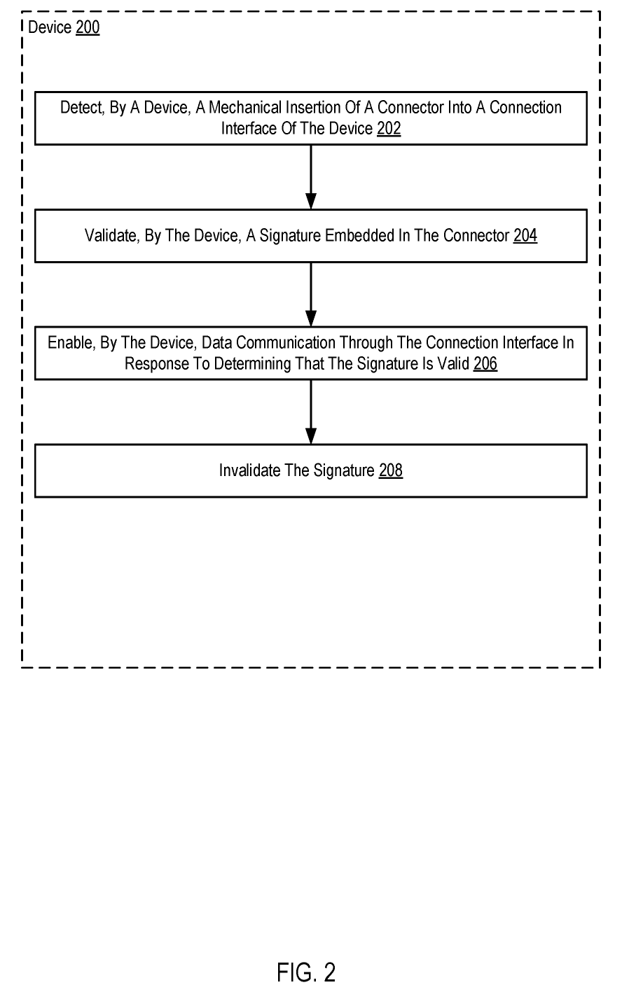

For further explanation, FIG. 2 sets forth an example method of authenticating physical connectors for improved computer system security in accordance with at least one embodiment of the present disclosure. The method includes detecting 202, by a device 200, a mechanical insertion of a connector into a connection interface of the device 200. In some examples, device 200 detects 202 the mechanical insertion of a connector into a connection interface of the device 200 by detecting a change in the electrical properties (e.g., voltage, capacitance, or resistance changes) or circuit continuity in the contacts of the connection interface. In other examples, device 200 detects 202 the mechanical insertion of a connector into a connection interface of the device 200 by detecting a mechanical force applied inside the connection interface, such as through spring loaded contact or pressure sensitive element.

The method of FIG. 2 also includes validating 204, by the device 200, a signature embedded in the connector. As discussed above, the connector includes a signature storage element. For example, the signature storage element may be an RFID tag, NFC chip, programmable logic device (e.g., an FPGA), storage device, or other device in which a signature is embodied. In some examples, at least part of the signature is encrypted via a protected key. For example, the signature may include plaintext and encrypted text that can be used to validate the plaintext. The device reads the signature from the signature storage element of the connector wirelessly or through a physical interface (e.g., a pin) on the connector. In a particular example, the connector is configured for wireless communication with the device. For example, the device 200 may include an NFC device and the signature storage element may be an NFC chip embedded in the connector. In such an example, the NFC device of the device 200 reads the signature from the NFC chip of the connector. In another example, the signature storage element is coupled to a pin in the connector that interfaces with a contact in the connection interface of the device. In such an example, the device reads the signature from the signature storage element via this pin.

In some examples, where at least part of the signature is encrypted, the device 200 validates 204 the signature embedded in the connector by decrypting the encrypted portion of the signature and comparing the decrypted text to a plaintext portion of signature. As the signature is encrypted and decrypted using a protected key, the device 200 can be assured that the connector is an authentic component for use with the device. In other examples, the device 200 validates 204 the signature embedded in the connector by comparing the signature to a list of valid signatures. For example, as a connector is programmed with a signature, that signature can be added to a signature datastore. When the device 200 reads the signature from the connector, it can look up the signature in the signature datastore to determine whether the signature is valid. If the signature is included in the list of valid signatures, the device 200 can be assured that the connector is an authentic component for use with the device.

The method of FIG. 2 also includes enabling 206, by the device 200, data communications through the connection interface in response to determining that the signature is valid. In some examples, the device 200 enables 206 data communications through the connection interface by activating the connection interface and allowing data traffic to pass through the connection interface. Data communications are enabled for the connection point only if the signature is validated. Otherwise, data communications through the connection point are blocked and data traffic is rejected. In this way, detecting the presence of connector, validating the embedded signature, and enabling network traffic only if the signature is validated can prevent network intrusion potentially carried out by plugging an unauthorized cable into the device 200, where a malicious actor may attempt to connect the device 200 to unauthorized computing equipment.

The method of FIG. 2 also includes invalidating 208 the signature. Invalidating the signature can include erasing the signature, overwriting the signature, marking the signature as invalid, removing the signature from a list of valid signatures, and/or mechanically breaking the signature storage element or wireless transmitter. In some implementations, the signature is invalidated in response to determining that the signature is valid. This prevents the signature from being reused and also prevents the connector from being unplugged and reinserted. Upon removal, the connector cannot be reinserted into the device 200 or any other device in a system for authenticating physical connectors for improved computer system security in accordance with the present disclosure because the connector no longer includes a valid signature. To reuse the connector, the connector must be programmed with a new valid signature.

In other implementations, the signature is invalidated by removing the connector from the connection interface of the device 200. For example, port locks may be used to ensure that connector cannot be removed until the port is deactivated. Prior to or contemporaneous with unlocking the port, the authentication controller may invalidate the signature on the connector. In another example, the connector may be configured such that mechanical forces applied to remove the connector from the connection interface will break the signature storage element, a transmission line coupled to the signature storage element, or a wireless transmitter coupled to the signature storage element, such that the connector is unable to provide a signature for reading. By invalidating the signature, the signature and thus connector are configured for one-time use. Invalidating the signature for one-time use further prevents network intrusion by ensuring that a cable cannot be swapped into a different port, or reinserted into the same port after removing and tampering with the connector/cable.

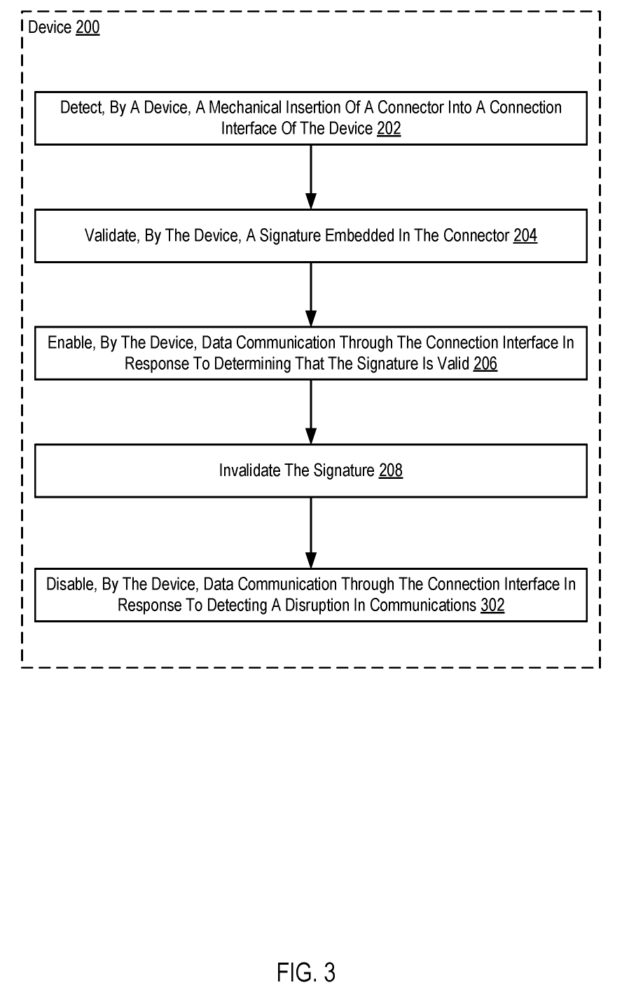

For further explanation, FIG. 3 sets forth another example method of authenticating physical connectors for improved computer system security in accordance with the present disclosure. The method of FIG. 3 extends the method of FIG. 2 in that the method of FIG. 3 also includes disabling 302, by the device, data communications through the connection interface in response to detecting a disruption in communications. In some examples, the device 200 disables 302 data communications through the connection interface by deactivating the connection interface or otherwise blocking or rejecting data traffic through the connection interface. The disruption in data communications may be caused by, for example, a removal of the connector from the device or a fault in a communications session (e.g., a TCP/IP session). For example, an opposite end of connector’s cable may be unplugged from another device, thus interrupting the communications session between the device 200 and the other device. After detecting the disruption, network traffic on the port is blocked/rejected. In this way, the connector/cable cannot be removed from the device, tampered with, and reinserted into the device, and also cannot be removed from another connected device, without the device 200 permanently blocking traffic on the connection interface until a connector with a valid signature is inserted. Also, slicing and splicing of the wiring of the cable, or tapping the cable, will cause a disruption in network traffic that is detected by the device 200, which will disable the connection interface in response. Thus, disabling 302 data communications through the connection interface in response to detecting a disruption in communications provides enhanced security by preventing a malicious actor from swapping or tapping cables in an effort to gain access to data or a network.

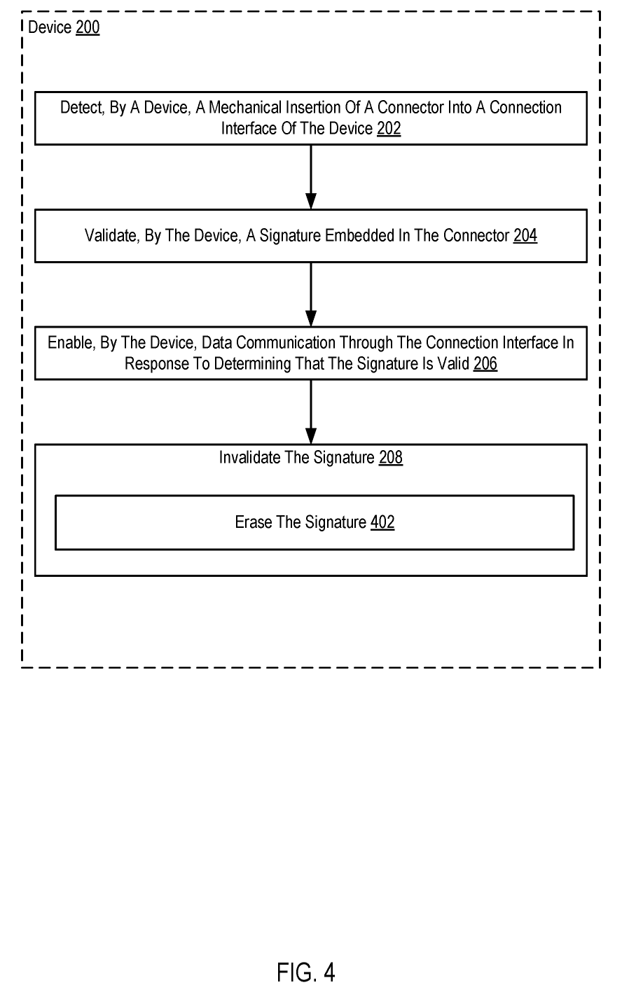

For further explanation, FIG. 4 sets forth another example method of authenticating physical connectors for improved computer system security in accordance with the present disclosure. The method of FIG. 4 extends the method of FIG. 2 in that invalidating 208 the signature includes erasing 402 the signature from the connector. For example, where the signature storage element in the connector is an NFC chip, the device 200 may use an NFC controller to erase or overwrite the signature stored the NFC chip. Also, where the signature storage element in the connector is a programmable logic device readable through a pin or contact, the device 200 may use the pin or contact to reprogram the programmable logic device to remove the signature. Thus, the signature is invalidated through erasure. In this way, after the first use, the connector cannot be removed and reinserted into the device 200 or any other device in a system configured for authenticating physical connectors for improved computer system security in accordance with the present disclosure. Because the connector no longer has a signature for validation, authentication of the connector will fail after removal.

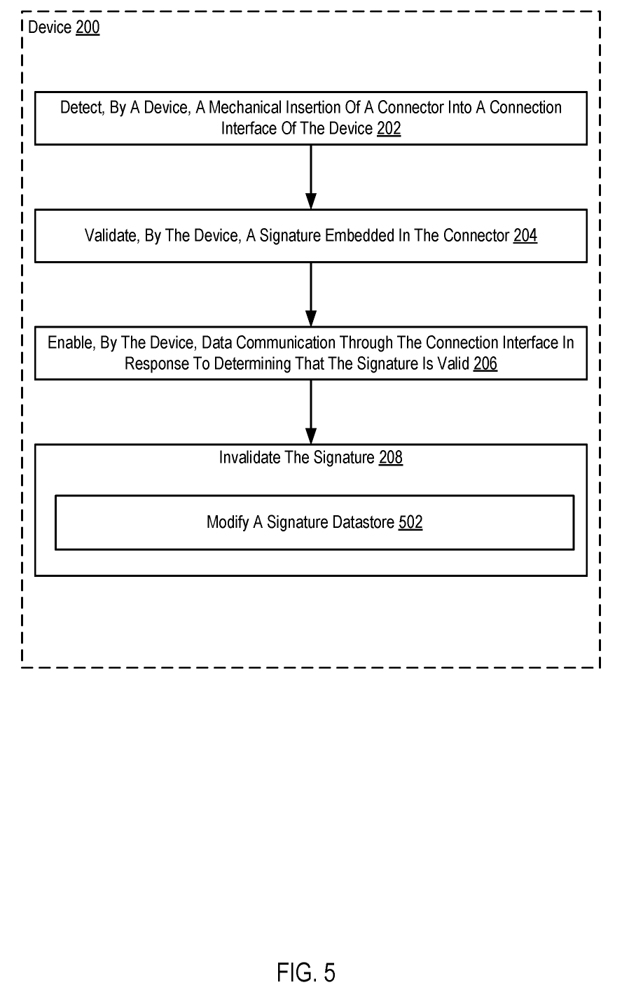

For further explanation, FIG. 5 sets forth another example method of authenticating physical connectors for improved computer system security in accordance with the present disclosure. The method of FIG. 5 extends the method of FIG. 2 in that invalidating 208 the signature includes modifying 502 a signature datastore. In some implementations, as discussed above, a signature is validated by cross-referencing the signature with a signature datastore that includes a collection of valid signatures. In some examples, the device modifies 502 a signature datastore to invalidate a signature by removing the signature from the signature datastore. In this way, a future lookup of the signature in the signature datastore will not find a match, and the signature will not be validated. In other examples, the device modifies 502 a signature datastore to invalidate a signature by marking an entry for the signature as invalid. As with the previous example, after marking a signature invalid, a future lookup of the signature in the signature datastore will reveal that the signature is invalid. In yet other examples, the device modifies 502 a signature datastore to invalidate a signature by adding the signature read from the connector to a block list. A future look-up of the signature in the signature datastore will find a match on the block list, thus indicating the signature has already been used and is no longer valid. In this way, after the first use, the connector cannot be removed and reinserted into the device 200 or any other device in a system configured for authenticating physical connectors for improved computer system security in accordance with the present disclosure. Because the connector no longer has a valid signature, authentication of the connector will fail after removal.

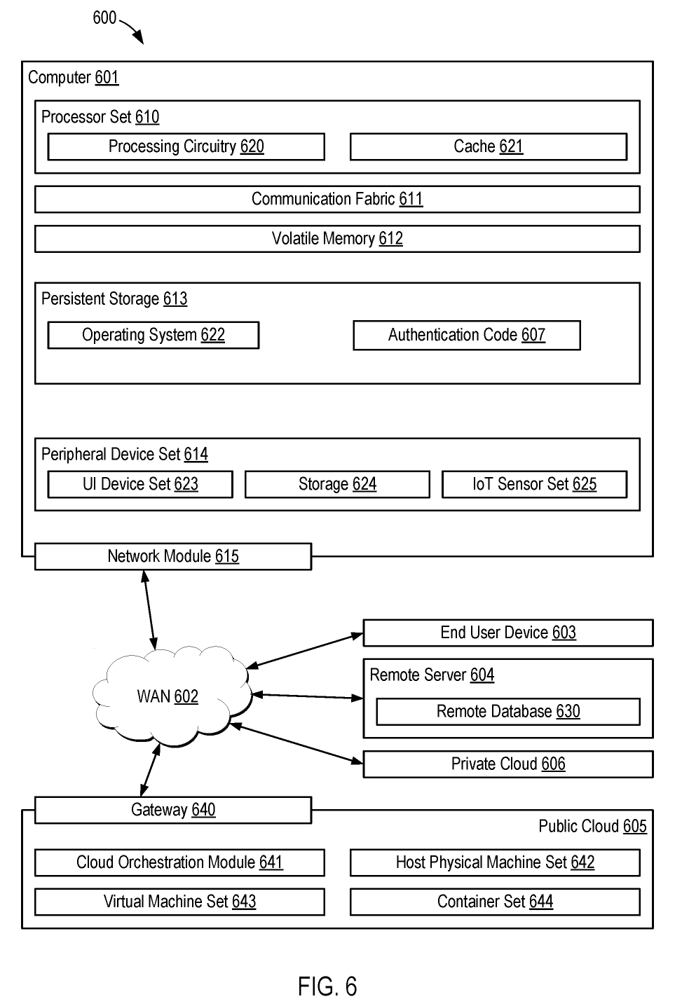

FIG. 6 sets forth an example computing environment according to aspects of the present disclosure. Computing environment 600 contains an example of an environment for the execution of at least some of the computer code involved in performing the various methods described herein, such as authentication code 607. In addition to authentication code 607, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and authentication code 607, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 621 and the other storage media discussed below. The program instructions, and associated data, are accessed by processor set 610 to control and direct performance of the computer-implemented methods. In computing environment 600, at least some of the instructions for performing the computer-implemented methods may be stored in authentication code 607 in persistent storage 613.

Communication fabric 611 is the signal conduction path that allows the various components of computer 601 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in authentication code 607 typically includes at least some of the computer code involved in performing the computer-implemented methods described herein.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database), this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the computer-implemented methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of authenticating physical connectors for improved computer system security, the method comprising:
detecting, by a device, a mechanical insertion of a connector into a connection interface of the device;
validating, by the device, a signature embedded in the connector;
enabling, by the device, data communication through the connection interface in response to determining that the signature is valid; and
invalidating the signature.

2. The method of claim 1 further comprising:
disabling, by the device, data communication through the connection interface in response to detecting a disruption in communications.

3. The method of claim 1, wherein the signature is wirelessly read from the connector.

4. The method of claim 1, wherein the signature is read from the connector over a physical interface.

5. The method of claim 1, wherein invalidating the signature includes:
erasing the signature from the connector.

6. The method of claim 1, wherein invalidating the signature includes:
modifying a signature datastore.

7. The method of claim 6, wherein the signature datastore is modified by removing the signature from the signature datastore.

8. The method of claim 6, wherein the signature datastore is modified by marking an entry for the signature in the signature datastore as invalid.

9. The method of claim 1, wherein the signature is invalidated in response to determining that the signature is valid.

10. The method of claim 1, wherein the signature is invalidated upon removal of the connector from the connection interface.

11. An apparatus comprising:
a processing device; and
memory operatively coupled to the processing device, wherein the memory stores computer program instructions that, when executed, cause the processing device to:
detect, by a device, a mechanical insertion of a connector into a connection interface of the device;
validate, by the device, a signature embedded in the connector;
enable, by the device, data communication through the connection interface in response to determining that the signature is valid; and
invalidate the signature.

12. The apparatus of claim 11, wherein the computer program instructions, when executed, cause the processing device to:
disable, by the device, data communication through the connection interface in response to detecting a disruption in communications.

13. The apparatus of claim 11, wherein the signature is wirelessly read from the connector.

14. The apparatus of claim 11, wherein the signature is read from the connector over a physical interface.

15. The apparatus of claim 11, wherein invalidating the signature includes:
erasing the signature from the connector.

16. The apparatus of claim 11, wherein invalidating the signature includes:
modifying a signature datastore.

17. The apparatus of claim 16, wherein the signature datastore is modified by removing the signature from the signature datastore.

18. The apparatus of claim 16, wherein the signature datastore is modified by marking an entry for the signature in the signature datastore as invalid.

19. The apparatus of claim 11, wherein the signature is invalidated in response to determining that the signature is valid.

20. A computer program product comprising:
a set of one or more computer readable storage media; and
computer program instructions, collectively stored in the set of one or more storage media, that when executed, cause a processor set to perform computer operations comprising:
detecting, by a device, a mechanical insertion of a connector into a connection interface of the device;
validating, by the device, a signature embedded in the connector;
enabling, by the device, data communication through the connection interface in response to determining that the signature is valid; and
invalidating the signature.
